(19) United States
(12) Patent Application Publication
(10) Pub. No.: US 2016/0101969 A1
(43) Pub. Date: Apr. 14, 2016

(54) DRIVE TRAIN FOR HOISTING GEAR

(71) Applicant: M.A.T. MALMEDIE ANTRIEBSTECHNIK GMBH, Solingen (DE)

(72) Inventors: Christof LAUTWEIN, Friesenhagen (DE); Christian SPURA, Castrop-Rauxel (DE); Christoph WAGENER, Geldern (DE)

(21) Appl. No.: 14/892,705

(22) PCT Filed: Feb. 12, 2014
(86) PCT No.: PCT/EP2014/052693

§ 371 Date: Nov. 20, 2015

(30) Foreign Application Priority Data
May 21, 2013 (DE) 10 2013 209 361.6

(51) Int. Cl. B66D 1/16; B66D 1/54; B66D 5/00; B66D 1/12

(52) U.S. Cl. CPC B66D 1/16; B66D 1/12; B66D 1/54; B66D 5/00

(57) ABSTRACT

A drive train is provided for hoisting gears, and in particular for hazardous transports. The drive train includes a drive motor (1), a cable drum (6) connected thereto, a reduction transmission (5) arranged between the drive motor (1) and the cable drum (6), a service brake (4) provided between the drive motor (1) and the reduction transmission (5) and a safety brake (7). To prevent damage to the reduction transmission (5) in the event of an emergency stop braking an automatic overrun disconnect means can be provided between the drive motor (1) and the service brake (4). The overrun disconnect means is preferably in the form of a freewheel (2).

### CROSS-REFERENCE TO RELATED APPLICATIONS

This application is a Section 371 of International Application No. PCT/EP2014/052693, filed Feb. 12, 2014 which was published in the German language on Nov. 27, 2014 under International Publication No. WO 2014/187578 A1 and the disclosure of which is incorporated herein by reference.

### BACKGROUND OF THE INVENTION

The invention concerns a drive train for hoisting gears, in particular for hazardous transports, comprising a drive motor, a cable drum connected thereto, a reduction transmission arranged between the drive motor and the cable drum, a service brake provided between the drive motor and the reduction transmission and a safety brake.

If hoisting gears are provided for the transport of hazardous items, for example molten materials or also radioactive materials, a safety brake is generally also provided in the drive train, besides the service brake. The safety brake which serves for emergency stop braking is normally carried on the shaft of the cable drum.

In an emergency stop braking situation in a “lower” load situation there is a reversal in the load direction and thus a torque shock occurs in the transmission, as a consequence of different application times for the safety brake and the service brake. That torque shock leads to an overload as well as stressing in the transmission. That overload and transmission stressing which occur upon emergency stop braking result in particular from the rotating inertial masses of the motor and the

BRIEF SUMMARY OF THE INVENTION

### Therefore the object of the invention is to avoid the torque shock linked to the reversal in the load direction and the stresses caused thereby in the transmission.

According to an embodiment of the invention that object is attained in that, provided between the drive motor and the service brake is an automatic overrun disconnect means.

These features according to an embodiment of the invention provide that the rotating masses of the motor are separated from the drive train. Damage in the drive train and in particular in

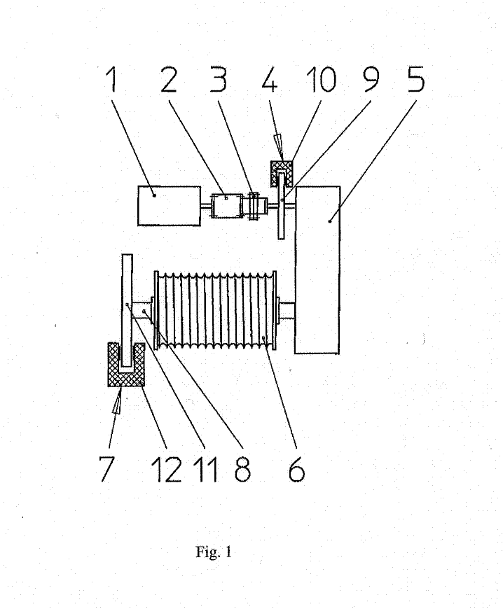

In the embodiment illustrated in FIG. 1, both the service brake 4 and also the safety brake 7 are designed in the manner of a disk brake.

The freewheel 2 arranged between the drive motor 1 and the coupling 3 is desirably in the form of a noiselessly operating clamping roller freewheel.

The coupling 3 arranged in FIG. 1 between the freewheel 2 and the service brake 4 is in the form of a rigid coupling.

Alternatively the coupling 3 can also be in the form of an electrically switchable releasable coupling to separate the drive motor 1 from the reduction transmission 5. For that specified case it would be possible to dispense with a freewheel 2.

If an emergency stop is triggered when lowering the suspended load the service brake 4 and the safety brake 7 are closed. By virtue of the usual brake dimensioning the safety brake 7 which serves as the emergency off stopping brake requires a shorter application time than the service brake 4. As a result the rotary movement of the cable drum 6 is stopped before the rotary movement of the input shaft of the reduction transmission has come to a halt. Thus, without the measures according to the invention, a shock torque would occur, which acts in the opposite direction to the actual load direction.

That torque transmitted by the inertia mass of the drive motor 1, in conventional drive trains, causes a shock-like reversal in direction of the torque in the transmission. The time process of the reversal in direction of the torque takes place during the difference in application times between the safety brake 7 and the service brake 4.

Then, in the conventional drive trains, the inertia mass in opposite relationship to the load direction produces in the reduction transmission 5 a change in tooth flank from the load flank to the opposite flank (rearward load flank). As a result of that, a shock loading occurs at the opposite flank, which in the conventional drive trains would lead to considerable damage to the transmission. That transmission damage can range from slight surface damage to the tooth flank to tooth breakage and thus failure of the transmission.

Such damage is very effectively prevented by the arrangement of an automatic overrun disconnect means or the freewheel 2 in the drive train according to the invention. It is already the case that upon response of the safety brake 7 which has a very short application time the freewheel 2 takes effect immediately upon stoppage of the reduction transmission 5, that is to say the torque of the inertial rotating masses of the drive motor, due to the response of the freewheel 2, is no longer transmitted to the reduction transmission 5 which is connected directly to the cable drum 6. The action of the freewheel 2 takes place immediately with actuation of the safety brake 7, and more specifically still before the service brake 4 provided with a lesser application time comes into engagement.

Consequently only one torque direction is predetermined by the arrangement of the freewheel 2 in the drive train according to the invention so that, in the event of emergency stop braking, no damage to the reduction transmission can occur. The features according to the invention can thus effectively protect a corresponding drive train for hoisting gears from damage so that the service life thereof is increased.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A drive train for hoisting gears comprising:
a drive motor (1),
a cable drum (6) connected thereto,
a reduction transmission (5) arranged between the drive motor (1) and the cable drum (6),
a service brake (4) provided between the drive motor (1) and the reduction transmission (5)
a safety brake (7), and
an automatic overrun disconnected means positioned between the drive motor (1) and the service brake (4).

2. The drive train of claim 1, wherein the overrun disconnect means is an overrun coupling.

3. The drive train of claim 2, wherein the overrun coupling is a freewheel (2).

4. The drive train of claim 3, wherein the freewheel (2) is a clamping roller freewheel.

5. The drive train of claim 1, wherein the overrun disconnect means is a releasable coupling.

6. The drive train of claim 5, wherein the releasable coupling is electrically switchable.
